(19) United States
(12) Patent Application Publication
(10) Pub. No.: US 2020/0332847 A1
(43) Pub. Date: Oct. 22, 2020

(54) WHEEL SYSTEM WITH BRAKE AND CORRESPONDING BRAKING ENHANCEMENT

(71) Applicant: RENAULT s.a.s, Boulogne-Billancourt (FR)

(72) Inventor: Nirmal CHAKARAVARTHI, Chennai (IN)

(73) Assignee: RENAULT s.a.s, Boulogne-Billancourt (FR)

(21) Appl. No.: 16/956,261

(22) PCT Filed: Dec. 20, 2018
(86) PCT No.: PCT/EP2018/086176

§ 371 Date: Jun. 19, 2020

(30) Foreign Application Priority Data
Dec. 22, 2017 (IN) 201731046341
Jan. 29, 2018 (FR) 1850700

(51) Int. Cl. F16D 63/00; B60B 9/28; B60B 15/20

(52) U.S. Cl. CPC F16D 63/00; B60B 15/20; B60B 9/28

(57) ABSTRACT

An automotive vehicle wheel and brake system includes a wheel axle, an angularly split wheel drum, the wheel drum including at least two separate wheel segments that are each radially movable, and a deforming actuator system including a deforming actuator to displace at least one of the wheel segments relative to at least another segment in such a way that an outer circumference of the wheel is temporarily deformed. The deforming actuator system also includes an electronic system that, during at least one predefined braking process, triggers the deforming actuator system so as to impose a temporary shape deformation of the split wheel drum.

The present invention relates to the field of braking systems for automotive vehicles.

Some concept cars are developed to adapt the contact between wheel and ground, sometime in harsh ground conditions or in swampy conditions.

For this purpose, angularly split wheels are sometimes developed.

One aim of the present invention is to improve braking efficiency of vehicles equipped with a new type of wheels.

To this purpose, an automotive vehicle wheel and brake system, may comprise:

a wheel axle,

an angularly split wheel drum, for rotating around the wheel axle, and for supporting the vehicle weight by contacting the ground directly or though a tire, the wheel drum comprising at least two separate wheel segments, each wheel segment being radially movable so as to vary its maximum outer radius measured from the wheel axle,

a deforming actuator system, comprising a deforming actuator configured to displace at least one of the wheel segments relative to at least another one of the segment, in such a way that an outer circumference of the wheel is temporarily deformed from a circular shape to a different shape (for instance such as an oval shape or a square shape). The different shape is advantageously such that, compared to the circular shape, the different shape increases the ground to wheel contact surface and/or it increases the ground to wheel contact span along the driving direction of the vehicle.

The deforming actuator system comprises an electronic system. The electronic system is configured to, during at least one predefined braking process, trigger the deforming actuator system so as to impose a temporary shape deformation of the split wheel drum.

The automotive vehicle may be a car, a two wheel vehicle or a single wheel vehicle.

The outer shape of the wheel may be for instance transformed from a circular shape to an oval shape or an elliptic shape, the larger axis of the oval or of the ellipse being parallel to the road.

According to some embodiments, when the deforming actuator system is triggered, a vertical segment may be forced to get shorter than two slanted segments preceding and following the vertical segments in an order of segments circling around the wheel. The vehicle body may then come closer to the ground during braking.

By “vertical segment”, we mean a segment for which the direction of a line joining a center of axle wheel, and the external point of the segment that is most distant from the axle wheel, is vertical. Definitions of “horizontal segments” and “slanted segment” can in deduced therefrom by analogy. By “length of a segment”, or “radial length of a segment”, we mean the length joining a center of axle wheel, and an external point of the segment that is most distant from the axle wheel. The segment preferably does not reach to the axle wheel-.

According to other embodiments, when the deforming actuator system is triggered, a vertical segment may remain of constant radial length, whereas than two slanted segments preceding and following the vertical segments may be forced to extend extend is meant relative to their previous radial length.

In this case the height of the vehicle body relative to the ground may remain almost unchanged.

The wheel may be surrounded by a common tire circling the different segments.

The tire itself may be supported by a deformable locking ring.

The wheel and brake system may also comprise:

a main braking system to stop rotational motion of the drum around the wheel axle,

an electronic system for triggering a braking process in view of stopping the vehicle,

a wheel speed estimator for estimating a rotational speed of the split drum,

a wheel position sensor for estimating an angular position of the split drum,

The electronic system may be configured to trigger the deformation actuator system to induce the temporary shape deformation of the split drum during a braking process, only when the angular speed of the wheel is less than a first speed threshold, and only when the position of the split drum is comprised within a predefined group of angular positions(s).

The predefined group of angular positions may ensure that the deformation actuator has the right interaction with the split drum, and also that the wheel segment which are displaced are at a right position, both relative to the actuator system and relative to the ground.

The main braking system may comprise a disk brake. A deforming actuator may then be assembled on a same axle end as a braking disk of the disk brake.

The wheel and brake system may be so configured, that during the braking process, the wheel segments are displaced by the deforming actuator, in such a way that the overall wheel shape is changed from an overall round shape to an elongated shape. During the braking, the wheel segments are preferably displaced radially during the braking.

According to an embodiment, the wheel drum may comprise two wheel segments which are configured to be extended or shortened in two radially opposed directions, so as to either extend the wheel diameter in one direction only, preferable along a horizontal direction, or, so as to shorten the wheel diameter along one direction, preferable along a vertical direction. The elongated shape of the drum may have an elongation ratio maximum diameter/minimum diameter comprised between 1.3 and 1.6.

The wheel may comprise at least three wheel segments so configured, that at least one wheel segment is configured to be radially extensible or retractable.

The wheel may comprise at least three wheel segments so configured, that at least two segments are configured to be radially extensible or retractable together by the deforming actuator, so as to both gain a different radial length than at least one other wheel segment.

The wheel segments may be surrounded by a common deformable locking ring. The locking ring may be designed to define the outer shape of the wheel Preferably, the locking ring is of round shape in a first configuration of the deforming actuator, and the locking ring is configured to get of elongated shape such as oval shape or elliptic shape in at least another configuration of the deforming actuator, corresponding to a braking configuration.

In some embodiments, all wheel segments are radially movable. The wheel and brake system then may comprise two radially expandable legs, each leg constantly pointing towards the ground, from a wheel axle leg end towards an outer leg end, along a fixed-relative to the ground slanted direction.

The wheel and brake system may also comprise a split drum configured to rotate around the expandable legs, so that each outer leg end constantly points towards at least one wheel segment, which segment may be pressed toward the outside of the wheel by the expandable leg,

The electronic system may be configured to trigger the deformation actuator system to expand the expandable legs during a braking process, only if the position of the split drum is comprised within a predefined group of angular positions(s).

Preferably, the angular spans of all wheel segments are the same.

Each wheel segment may have a pressing surface facing the center of the wheel, and circling around the outer leg ends. The wheel segment itself may have a centering portion extending to the inside of the wheel, the centering portion coming closer to the wheel axle than the radius of the pressing surfaces the latter imposed by the outer radius of the outer leg ends.

The outer leg end of each expandable leg may be equipped with a contacting roller. In normal driving condition of the vehicle, the contacting roller may roll on the successive pressing surfaces circling around the leg end. In braking condition, the roller may be used to exert a pressing force from the leg to the wheel segment, the force being applied radially toward the outside of the wheel.

Preferably, the angular span of each wheel segment is larger than an angular span of a movable end portion of the expandable legs so that, for a group of specific angular positions of the drum, each expandable leg may be triggered

The wheel and brake system may also comprise:
a rotating hub for maintaining the wheel segments rotating around the wheel axle,
a group of radial pressing struts, for connecting the hub and each wheel segment, and for applying a radial force between the hub and each wheel segment, so as to press each wheel segment radially against the deformable locking ring.

In this way, the final outer shape of the locking ring, results : from the pressing strut forces, from the elastic behavior of the locking ring, and from the action, when action is triggered, of the expandable legs

The pressing struts may each comprise a spring and/ or a hydraulic piston.

The expandable legs may comprise hydraulic pistons, and may be controlled by the electronic system.

The wheel and brake system may also comprise :

a main disk braking system to stop rotational motion of the hub around the wheel axle,

at least an angular detection means for estimating an angular position of at least one wheel segment relative to each leg, and for determining at which moments an expansion of the legs makes the legs is preferably so configured that the action of the pressing struts bring the deformable locking ring back to its usual circular shape once the action of the expandable legs is stopped.

The invention also relates to an automotive vehicle comprising at least two front wheel and brake system as described above, and/or comprising at least two rear wheel and brake system as described above.

The invention also comprises a process of brake enhancement, in which an actuator system changes the external shape of a vehicle wheel when the rotational speed of the wheel has already been decreased below a first limit. Preferably, the actuator system changes the external shape of a vehicle wheel so as to elongate the wheel shape along a direction parallel to the ground. In some embodiments, the actuator system may be triggered for certain angular positions only.

The present invention and its advantages will be better understood upon reading hereafter the detailed description of one particular embodiment illustrated by the appended drawings, this embodiment being cited as a non limiting example.

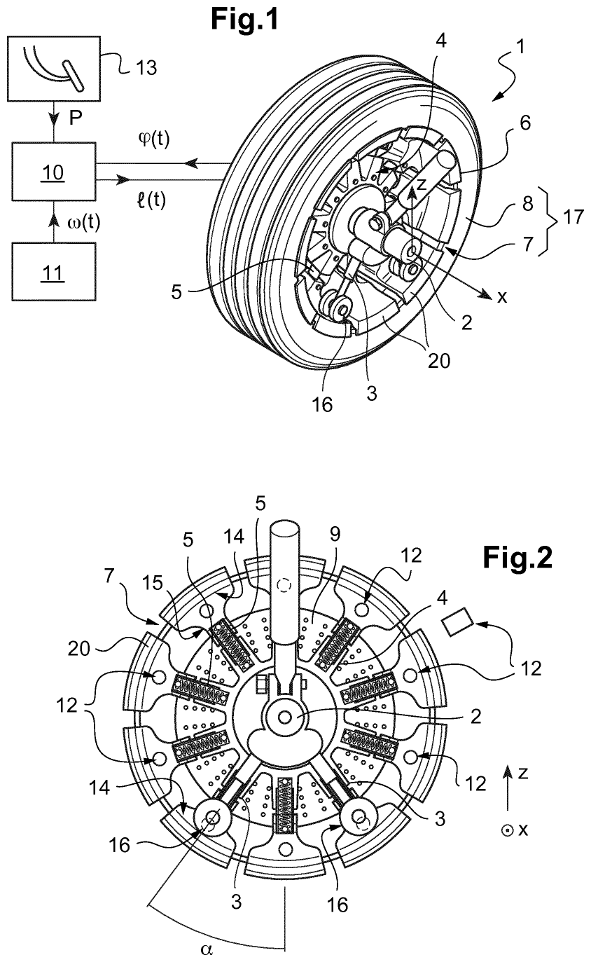

FIG. 1 is a schematic description of a wheel and brake system according to the invention;

FIG. 2 shows a vertical section of a portion of wheel belonging to the system of FIG. 1;

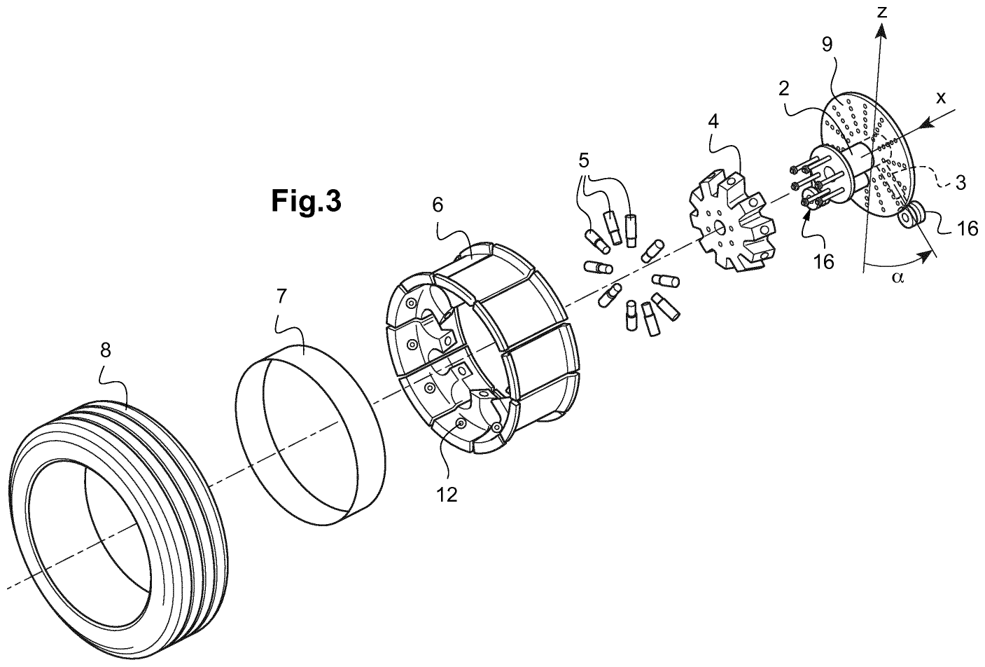

FIG. 3 is an exploded view of a wheel belonging to the system of FIG. 1.

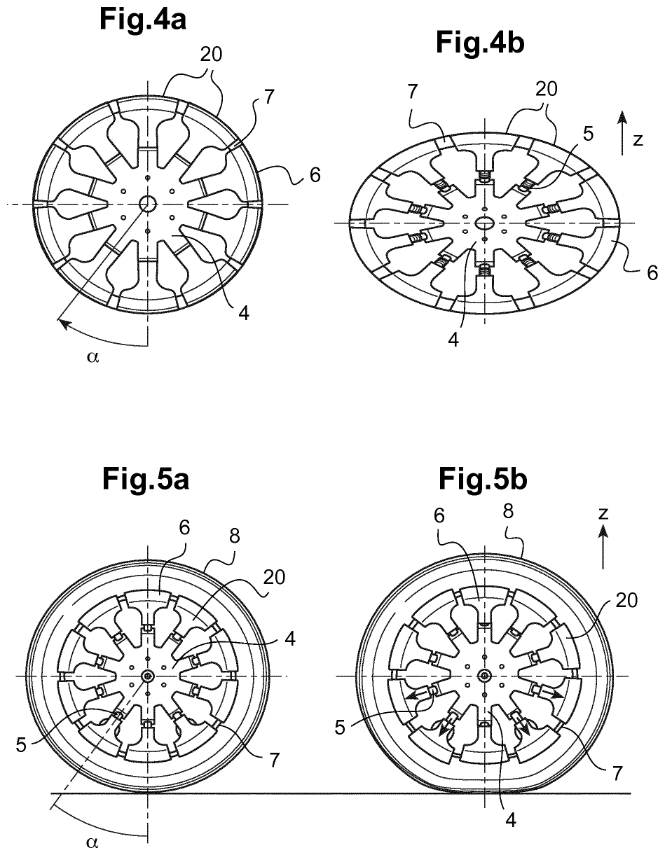

FIGS. 4a and 4b illustrate one possible deformation pattern of a wheel belonging to an embodiment of the present invention;

FIGS. 5a and 5b illustrate another possible deformation pattern of a wheel belonging to an embodiment of the present invention;

As illustrated on FIG. 1, a wheel and brake system 1 comprises:

an axle end 2, attached to the vehicle body, and configured to impose the rotational axis of the wheel,

a central hub, rotating around the axle end,

an angularly split drum 6, comprising a number of wheel segments 20, here 10 wheel segments of same angular amplitude,

radial pressing struts, here radial springs 5, for exerting a radial force between the hub 4 and wheel segments 20; The springs may be partially inserted into the hub at one end, and/or into wheel segments at the other end; They may, alternatively, be placed around protruding portions of either hub and/or wheel segments; There may be a radial guidance by hub portions penetrating wheel segments, or the opposite.

The wheel system also comprises a deformable locking ring 17, here comprising a metallic, elastomeric or composite locking element 7, and also comprising a tire circling the locking element 7 and the wheel segments 20. The locking element here counterbalances the forces exerted by the springs 5, and also offers support for the tire 8.

The wheel and brake system comprises two actuator legs 3, with an inner end attached to the axle end , and an outer end equipped with a roller 16 placed so as to press onto one of the wheel segments, when the leg is expanded. The leg direction is at a slant, that is forming an angle a with the vertical direction of the vehicle. The angle α may be comprised between 20° and 90° for example.

The wheel and brake system comprises an electronic system 10, which is configured to detect a need for braking and/or a braking signal emitted from a braking pedal 13.

The electronic system comprises a wheel speed estimator 11 which is configured to measure, or to calculated, a rotational speed of the wheel. The electronic system also comprises wheel position sensor systems 12 (illustrated on FIG. 2). When braking is requested, the electronic system may, at a specific time during the braking process, trigger an expansion l(t) of the actuator legs 3, taking into account a rotation speed ω(t) of the wheel, and an angular position φ(t) of the wheel. The expansion of actuator legs 3 provokes a change in the overall outer shape of the wheel, increasing contact surface between tire and road. This secondary braking process can be triggered when the wheel has already been slowed down by a main braking process, for instance by a disk braking process.

FIG. 2 shows a vertical section of a portion of wheel belonging to the system of FIG. 1; Some elements are already depicted on FIG. 1, same elements being designated by same references.

As can be seen on FIG. 2, each wheel segment may have a pressing surface 14 facing the center of the wheel, and circling around the rollers 16 of the outer leg ends, so as to contact the rollers, avoiding brutal contact between leg and wheel segment when the leg is triggered to expand. The wheel segment itself may have a centering portion 15 extending to the inside of the wheel, the centering portion 15 coming closer to the wheel axle, than the contacting radius imposed by the outer radius of the outer leg ends.

The wheel may be equipped with a primary braking system, here a braking system with a disk 9.

In order to improve contact surface with the ground, leg expansion is tailored to change the overall shape of the wheel, and the overall shape of locking element 7 and split drum 6 underneath.

FIG. 3 is an exploded view, to better distinguish between the different components of the wheel, allowing to get an actively deformable wheel.

Some elements are already depicted on FIGS. 1 and 2, same elements being designated by same references. Elements 2, 3, 16 on the right of the image have a constant angular position relative to axis x corresponding to geometrical axis of the wheel axle. Elements 4, 5, 6, 12, 7, 8 on left side of the image, as well as the rotating brake disk 9, rotate around axis x during driving of the vehicle.

As can be seen on FIG. 3, the leg system 3, or more generally the deforming actuator 3, is preferably placed along the axis x of the wheel, so as to be closer to the vehicle central frame, than the rotating brake disk 9. In this way, the deformable wheel system can be delivered as a whole system preassembled around a central stub axle. Both the brake disk 9 and actuator system 3 may be delivered pre-mounted around the stub axle. After the stub axle has been assembled onto the vehicle frame, the actuator system 3 may then be blocked in rotation relative to the vehicle frame. For instance, long screws (not depicted on the pictures), traversing the frame and the deforming actuator system, may be inserted to this purpose.

FIG. 4a illustrates a wheel shape during driving, FIG. 4b illustrates the same wheel portion during braking. All pressing struts are here elongated once the legs are triggered; the shape changes from round on FIG. 4a to elliptic on FIG. 4b. Some elements are already depicted on FIG. 1, same elements being designated by same references.

FIG. 5a illustrates, in a different embodiment, a wheel shape during vehicle driving, FIG. 5b illustrates the same wheel portion during braking. Once the legs are triggered to extend, vertical pressing struts get shorter, whereas lateral struts are elongated. The shortening of the vertical legs may be obtained thanks to the reaction of the deformable locking element 7 to the pressure exerted by the actuator legs 3, by choosing an appropriate a angle of the legs. In this embodiment, the wheel shape changes from round on FIG. 5a to oval on FIG. 5b. Some elements are already depicted on FIG. 1, same elements being designated by same references.

The braking system and associated braking process according to the invention, has been estimated to reduce emergency braking distance to about a half of braking distance without active wheel shape change, for initial vehicle speeds comprised between 50 km/h and 200 km/h.

1-10. (canceled)

11. An automotive vehicle wheel and brake system, comprising a wheel axle;
an angularly split wheel drum to rotate around the wheel axle and to support the vehicle weight by contacting the ground directly or through a tire, the wheel drum comprising at least two separate wheel segments that are each radially movable so as to vary a maximum outer radius measured from the wheel axle;
a deforming actuator system comprising a deforming actuator configured to displace at least one of the wheel segments relative to at least another of the wheel segments such that an outer circumference of a wheel is temporarily deformed from a circular shape to a different shape,
wherein the deforming actuator system comprises an electronic system that is configured to, during at least one predefined braking process, trigger the deforming actuator system so as to impose a temporary shape deformation of the split wheel drum.

12. The automotive vehicle wheel and brake system according to claim ii, further comprising:
a main braking system to stop rotational motion of the drum around the wheel axle;
a wheel speed estimator to estimate a rotational speed of the split drum; and
a wheel position sensor to estimate an angular position of the split drum,
wherein the electronic system is configured to trigger a braking process in view of stopping the vehicle, and
wherein the electronic system is configured to trigger the deforming actuator system to induce the temporary shape deformation of the split drum during the braking process when the angular speed of the wheel is less than a first speed threshold, and when the position of the split drum is within a predefined group of angular positions.

13. The automotive vehicle wheel and brake system according to claim 11, wherein, during the predefined braking process, the wheel segments are displaced by the deforming actuator, in such a way that an overall wheel shape is changed from an overall round shape to an elongated shape.

14. The automotive vehicle wheel and brake system according to claim 13, wherein the wheel comprises at least three of the wheel segments that are configured such that at one of the wheel segments is configured to be radially extensible or retractable relative to at least one other of the wheel segments.

15. The automotive vehicle wheel and brake system according to claim 14, wherein at least two of the segments are configured to be radially extensible or retractable together by the deforming actuator so as to both gain a different radial length than at least one other of the wheel segments.

16. The automotive vehicle wheel and brake system according to claim 13, wherein the wheel segments are surrounded by a common deformable locking ring, the locking ring defining an outer shape of the wheel, the locking ring having a round shape in a first position of the deforming actuator, and the locking ring having an elongated shape in at least another position of the deforming actuator.

17. The automotive vehicle wheel and brake system according to claim 16, wherein which all of the wheel segments are radially movable, and wherein the wheel and brake system further comprises:
two radially expandable legs, each leg end constantly pointing, from a wheel axle leg end towards an outer leg end, at a fixed slanted direction towards the ground,
a split drum configured to rotate around the expandable legs so that each outer leg end constantly points towards at least one of the wheel segments, and is configured be pressed toward the outside of the wheel against the expandable leg,
wherein the electronic system is configured to trigger the deforming actuator system to expand the expandable legs during a braking process when the position of the split drum is within a predefined group of angular positions.

18. The automotive vehicle wheel and brake system according to claim 17, further comprising:
a rotating hub configured to maintain the wheel segments rotating around the wheel axle; and
a group of radial pressing struts to connect the hub and each wheel segment, and to apply a radial force between the hub and each wheel segment, so as to press each wheel segment radially against the deformable locking ring.

19. The automotive vehicle wheel and brake system according to claim 18, further comprising:
a disk braking system configured to stop rotational motion of the hub around the wheel axle; and
an angular detection means for estimating an angular position of at least one of the wheel segments relative to one of the legs, and for determining at which moments an expansion of the legs makes the legs press on only one of the wheel segments.

20. An automotive vehicle comprising:
at least two of the automotive vehicle wheel and brake system according to claim 11 as front wheels of the vehicle or as rear wheels of the vehicle.
